(19) United States
(12) Patent Application Publication
(10) Pub. No.: US 2009/0305077 A1
(43) Pub. Date: Dec. 10, 2009

(54) FRICTION WELDED PART, SUSPENSION ROD FORMED OF THE FRICTION WELDED PART, AND JOINING METHOD

(76) Inventors: Kou Mizuguchi, Tokyo (JP); Shinichiro Sumi, Shizuoka-shi (JP); Kazuhiro Nakakura, Niigata-shi (JP); Hiroyuki Mochizuki, Shizuoka (JP)

Correspondence Address: CROWELL & MORING LLP;INTELLECTUAL PROPERTY GROUP, P.O. BOX 14300, WASHINGTON, DC, 20044-4300, US

(21) Appl. No.: 12/374,233

(22) PCT Filed: Jul. 19, 2006
(86) PCT No.: PCT/JP2006/314217

§ 371 Date: Aug. 14, 2009

(51) Int. Cl. B32B 15/01; B23K 20/12; B32B 15/00

(52) U.S. Cl. 428/654; 228/112.1; 428/615

(57) ABSTRACT

The present invention provides a friction welded part which can be easily designed, a suspension rod formed of the friction welded part, and a joining method.

A friction welded part (1) is formed by friction welding a first member (10) at least whose first joining portion is formed into a cylindrical shape, and a second member (20) having an appropriate shape. The second joining portion (21) of the second member (20) is formed into a bottomed cylindrical shape corresponding to the first joining portion (10A), and the inside of the cylinder is formed into a curved surface continuing from the cylindrical inner wall portion (21C) to the bottom portion (21B), and the first joining portion (10A) of the first member (10) and the second joining portion (21) of the second member (20) are joined by friction welding.

### TECHNICAL FIELD

The present invention relates to a friction welded part, a suspension rod formed of the friction welded part, and a joining method.

### BACKGROUND ART

Recently, as a joining method for a pipe-shaped member and a rod-shaped member, a joining method using friction welding has been widely adopted. In this friction welding, joining end surfaces of members to be joined are butted while they are rotated relative to each other and the joining interface is frictionally heated, and thereafter, immediately before the relative rotation is stopped or after the relative rotation is stopped, an upset pressure is applied to join the members at the joining interface.

For a suspension rod constituting a vehicle suspension, such as an upper link, a lower link, a radius rod, and a torque rod, etc., iron steel materials are conventionally used, however, in view of weight reduction of a vehicle, in recent years, aluminum alloy materials are often used. For example, in Japanese Published Unexamined Patent Application No. H11-156562, a suspension rod which includes end members made of an aluminum alloy friction-welded to both ends of a rod member formed of an aluminum alloy-made pipe-shaped member is disclosed.

Generally, when end members as solid-core members are friction-welded to a rod member formed of a pipe-shaped member, to prevent the heat capacity and friction welding conditions from being greatly different between members to be friction-welded, joining portions of the end members are formed to be hollow corresponding to the joining portions of the rod member before the friction welding. Accordingly, proper friction welding of the rod member and the end members is performed.

### DISCLOSURE OF THE INVENTION

### Problem to be Solved by the Invention

In the conventional joining by friction welding of a rod member and an end member, as shown in FIG. 6(a) and FIG. 6(b), a joining portion 41 of a solid-core end member 40 is drilled to be hollow corresponding to a joining portion 51 of a pipe-shaped rod member 50, and in this case, angulated portions X and Y were formed on the bottom, and stress concentration at the angulated portions X and Y occurs and could result in deterioration of fatigue strength. Therefore, strength design was difficult.

Further, when a heat affected zone when friction welding is performed ranged over the angulated portions X and Y, strength design became more difficult.

Further, in the joining by friction welding, generally, stress changes caused by section changes of the end member must be considered, so that in addition to the complicated design of the suspension rod, the design became more difficult due to the above-described circumstances.

This is true not only in the friction welding of an end member to a rod member but also in friction welding of a second member to a first member.

In view of these circumstances, an object of the present invention is to provide a friction welded part which is easily designed, a suspension rod formed of the friction welded part, and a joining method.

### Means for Solving the Problem

In order to solve the above-described problem, the present invention provides a friction welded part formed by friction welding a first member at least whose first joining portion is formed into a cylindrical shape and a second member having an appropriate shape, wherein a second joining portion of the second member is formed into a bottomed cylindrical shape corresponding to the first joining portion, and an inside of the cylindrical shape are formed into a curved surface continuing from a cylindrical inner wall portion to a bottom portion; and wherein the first joining portion of the first member and the second joining portion of the second member are joined by friction welding.

According to the above-described configuration, the second joining portion of the second member is shaped into a bottomed cylindrical shape corresponding to the first joining portion, and the inside of the cylinder is formed into a curved surface continuing from the cylindrical inner wall to the bottom portion so as not to have angulated portions, so that stress concentration in the vicinity of the bottom portion formed by drilling does not occur, and the design of the friction welded part becomes easy. In addition, stress concentration at angulated portions does not occur, so that a friction welded part which has strength that is not deteriorated and has high fatigue strength can be manufactured.

In addition, stress concentration does not occur in the vicinity of the bottom portion formed by drilling, so that an increase in thickness for coping with the stress concentration is unnecessary, and the thickness of the second joining portion formed into a bottomed cylindrical shape for friction welding can be reduced, and accordingly, the thickness of the first joining portion formed into a cylindrical shape can also be reduced. In other words, both first joining portion and second joining portion can be formed to be thin in thickness. Therefore, a friction welded part which contributes to weight reduction while maintaining joining strength is obtained.

Further, the bottom portion is formed into a curved surface in the section including an axis line, and for example, it is preferable that the bottom portion is formed to have a sectional shape having no angulated portions even at the bottom portion center, and with this configuration, stress concentration at a portion where the sectional shape changes does not occur, and the design of the friction welded part becomes easier.

Further, it is preferable that a cylindrical portion of the second joining portion of the second member formed into the bottomed cylindrical shape is formed to have lengths capable of including a heat affected zone when friction welding is performed.

With the above-described configuration, a heat affected zone (HAZ) which has different strength and quality from those of the second member inevitably occurs in the vicinity of the joining interface due to frictional heat when welding, however, the second joining portion is formed to have a length capable of including the heat affected zone, so that the heat affected zone when welding is present only on the cylindrical portion which has no sectional shape changes, and does not range over the bottom portion side where the sectional shape changes and a junction side formed to be, for example, hollow continuously to the cylindrical portion, from the cylindrical portion. Therefore, with regard to the bottom side, there is no need to consider strength changes caused by heat influence, and the design of the friction welded part becomes easy.

It is a preferable configuration that the second joining portion of the second member has an inner diameter and an outer diameter equal to those of the first joining portion of the first member.

With the above-described configuration, the second joining portion of the second member and the first joining portion of the first member have the same section, so that the design becomes easy. These are joined with the same section, and when friction welding is performed, the second joining portion and the first joining portion are frictionally heated in substantially the same condition, and heat is transferred in substantially the same condition, and the welding balance of these becomes excellent and the joining strength is improved accordingly. In addition, an advantage of easy welding control in friction welding is also obtained. Further, burr shapes can also be easily controlled.

A suspension rod of the present invention is a suspension rod formed of the friction welded part, and includes a rod member as a first member and end members as a second member which are formed by cutting an aluminum alloy-made extrusion material, and the second joining portion having a bottomed cylindrical shape is formed on the end members.

With the above-described configuration, the rod member as the first member and the end members as the second member are formed by cutting-out an aluminum alloy-made extrusion material, so that productivity of the suspension rod is improved. Further, by utilizing the property of the aluminum alloy in that it is lightweight in spite of its strength and hardly corrodes, a vehicle can be reduced in weight.

By forming the second joining portion having the bottomed cylindrical shape on the end members, the rod member and the end member which are different in shape from each other can be easily joined by friction welding, then manufacturing of the suspension rod becomes easy.

Further, as a preferable configuration, the end members are formed of an extrusion material having a hollow portion, and this hollow portion is formed into almost the same shape as a hollow portion to which a rubber bush can be fitted, and a portion where the second joining portion is formed by cutting-out the aluminum alloy-made extrusion material, and the second joining portion is formed by machining such as cutting from the portion of the cut-out aluminum alloy-made extrusion material.

With this configuration, a hollow portion having dimensional accuracy for allowing a rubber bush to be fitted thereto can be easily formed by cutting-out an aluminum alloy-made extrusion material, then the productivity is improved. The second joining portion is formed by machining the predetermined portion of the aluminum alloy extrusion material, so that, for example, the cylindrical portion and the bottom portion can be easily formed by cutting, etc. An advantage of a high degree of freedom in formation of the second joining portion is also obtained.

The joining method of the present invention is a method for friction welding a second member having an appropriate shape to a first member at least whose first joining portion is formed into a cylindrical shape, including steps of forming a second joining portion of the second member into a bottomed cylindrical shape corresponding to the first joining portion; forming an inside of the cylindrical shape into a curved surface shape continuing from a cylindrical inner wall portion to a bottom portion; bringing the first joining portion of the first member and the second joining portion of the second member into contact with each other; butting the first and the second joining portions while rotating the first and the second joining portions relative to each other; and friction welding the first and the second joining portions.

According to this joining method, the second joining portion of the second member is formed into a bottomed cylindrical shape corresponding to the first joining portion, and the inside of the cylinder is formed into a curved surface continuing from the cylindrical inner wall portion to the bottom portion and has no angulated portions, so that stress concentration does not occur in the vicinity of the bottom portion formed by drilling while friction welding, and the friction welded part is easily designed. Stress concentration due to angulated portions does not occur, so that the strength is not deteriorated, and the fatigue strength is high and durability is increased. Accordingly, a friction welded part and a suspension rod which can be used for a long time can be manufactured.

Stress concentration due to angulated portions does not occur, so that stress concentration does not occur in the vicinity of the bottom portion formed by drilling, and the second joining portion formed into a bottomed cylindrical shape for friction welding can be thinned. Accordingly, the thickness of the first joining portion formed to be cylindrical can also be reduced. In other words, both the first joining portion and the second joining portion can be formed to be thin. Therefore, a friction welded part and a suspension rod which contribute to weight reduction while maintaining the joining strength are obtained.

In the joining method in which the bottom portion of the second joining portion is formed to have a sectional shape with no angulated portions in the axial direction, stress concentration at a portion where the sectional shape changes does not occur, so that a friction welded part and a suspension rod which are easily designed can be obtained.

In the joining method in which the cylindrical portion of the second joining portion of the second member formed into a bottomed cylindrical shape is formed to have a length capable of including a heat affected zone when friction welding is performed, the heat affected zone which is generated due to the frictional heat in the welding is present only at the cylindrical portion having no change in sectional shape, and does not range over a portion where the sectional shape changes (sectional shape changed portion). Therefore, there is no need to consider strength changes due to thermal influence on the sectional shape changed portion, so that a friction welded part and a suspension rod which are easily designed can be obtained.

### EFFECT OF THE INVENTION

According to the friction welded part of the present invention, the design thereof becomes easy. According to the suspension rod of the present invention, the design thereof also becomes easy. According to the joining method of the present invention, a friction welded part and a suspension rod which are easily designed can be obtained.

### BRIEF DESCRIPTION OF THE DRAWINGS

FIG. 1(a) is a sectional view showing a suspension rod formed of a friction welded part, and FIG. 1(b) is a sectional view showing a rod member and end members before being friction welded;

FIG. 2(a) to FIG. 2(c) are explanatory views showing forming steps of the end member;

FIG. 3(a) is an enlarged sectional view showing the surrounding of a friction welded portion, and FIG. 3(b) is an enlarged sectional view showing a state where a burr caused by friction welding is cut off;

FIG. 4 is a time chart for describing a friction welding method;

FIG. 5(a) is a sectional view showing a suspension rod formed of another friction welded part, and FIG. 5(b) is similarly a sectional view showing a rod member and end members before being friction welded; and

FIG. 6 are views showing a conventional suspension rod, and FIG. 6(a) is a sectional view showing a rod member and an end member before being friction welded, and FIG. 6(b) is a sectional view showing the rod member and the end member after being friction welded.

### DESCRIPTION OF THE REFERENCE NUMERALS

1 suspension rod (friction welded part)
10 rod member (first member)
10A, 10B end portion (first joining portion)
10a, 21a end surface
20 end member (second member)
21 joining portion (second joining portion)
21A cylindrical portion
21B bottom portion
22 junction
22A hollow portion
H heat affected zone
J joining interface

### BEST MODE FOR CARRYING OUT THE INVENTION

A best mode for carrying out the present invention will be described in detail with reference to the accompanying drawings. In the following embodiment, the friction welded part is a suspension rod which is one of the suspension parts, however, this is not intended to limit the use of the friction welded part of the present invention.

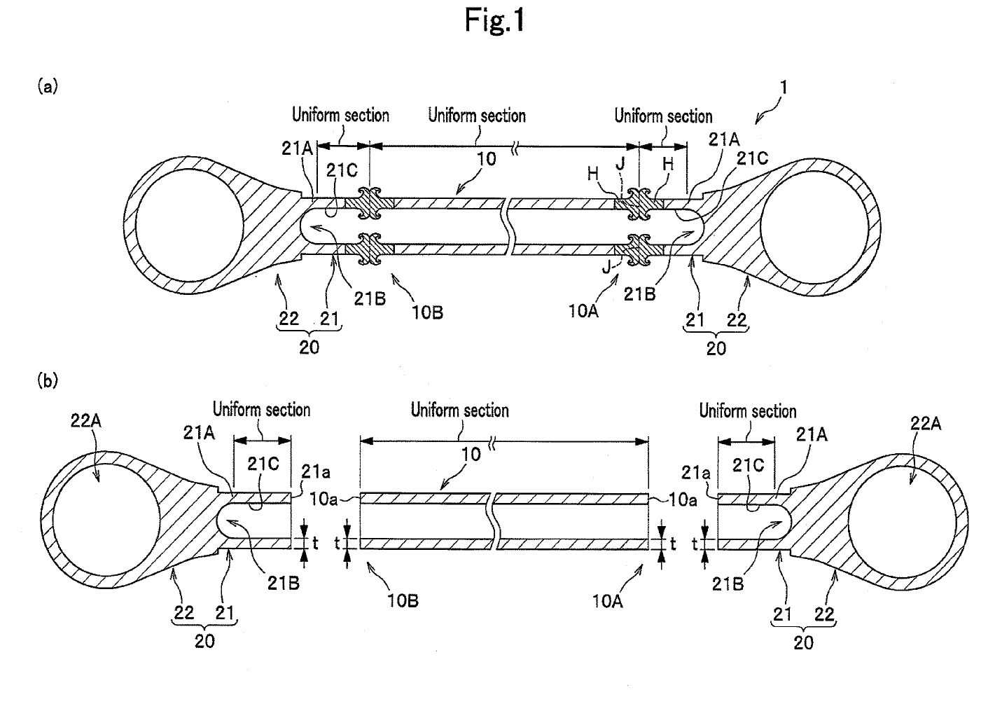

As shown in FIG. 1(a), a suspension rod 1 formed of a friction welded part of the present embodiment is formed by joining end members 20 and 20 as second member to both end portions 10A and 10B of a rod member 10 as a first member by friction welding. Around the respective joining interfaces J of the rod member 10 and the end members 20 and 20, heat affected zones H (shaded areas in the drawing) are formed.

As shown in FIG. 1(b), the rod member 10 is formed by cutting-out an aluminum alloy-made extrusion material in a circular tube shape, and has an entirely uniform section. In other words, the rod member 10 before being friction welded has a cylindrical shape which has an inner diameter and an outer diameter constant in the extraction direction (longitudinal direction), and does not have changes in section. The rod member 10 does not need to be formed entirely uniform in section, and it is required that at least both end portions 10A and 10B to be friction welded to end members 20 and 20 have a uniform section. Both end portions 10A and 10B correspond to “first joining portion” of claim 1. Here, “cutting-out an aluminum alloy-made extrusion material” means “cutting an aluminum alloy-made extrusion material,” which is cutting with a saw or miller, etc., (the same applies to the following description).

Both end portions 10A and 10B of the rod member 10 after being friction welded are, as shown in FIG. 1(a), thicker at the joining interfaces J and in the vicinity of these than the thickness t (see FIG. 1(b)) before being friction welded.

The end members 20 and 20 are formed by cutting-out an aluminum alloy-made extrusion material, and include joining portions 21 and 21 and junctions 22 and 22 which are formed continuously to the joining portions 21 and 21. Major configurations of the two end members 20 and 20 are the same, so that one end member 20 will be described in the following description. Here, the joining portions 21 correspond to the “second joining portion” of claim 1.

The joining portion 21 of the end member 20 has a bottomed cylindrical shape, and has a cylindrical portion 21A formed to have a uniform section with no section changes, and a bottom portion 21B continued to the cylindrical portion 21A.

In the present embodiment, the cylindrical portion 21A is formed to have the same sectional shape as that of the end portion 10A of the rod member 10. In other words, the cylindrical portion 21A of the end member 20 has the same inner diameter and the same outer diameter as those of the end portion 10A of the rod member 10.

The cylindrical portion 21A is formed to have a length including the heat affected zone H on the joining portion 21 side when friction welding is performed (that is, the cylindrical portion 21A is formed to be longer than the heat affected portion H) so that, as described later, when friction welding is performed, the heat affected zone H does not range over the bottom portion 21B side with changes in section from the cylindrical portion 21A. In other words, when friction welding is performed, the heat affected zone H is generated only on the cylindrical portion 21A, and accordingly, design by considering heat influence of friction welding is not necessary at the portion on the bottom portion 21 side where the section changes. The bottom portion 21B may be provided so as to have a depth reaching the inside of the junction 22 from the joining portion 21 side.

When the rod member 10 is structured so as not to have an entirely uniform section, it is necessary to form a uniform section portion having a length including the heat affected zone H on both end portions 10A and 10B of the rod member 10.

The inside of the cylinder of the joining portion 21 is formed into a curved surface continuing from the cylindrical inner wall portion 21C to the bottom portion 21B, and the bottom portion 21B is formed into a curved surface with no angulated portions in the section including the axis line of the joining portion 21. In the present embodiment, the bottom portion 21B is formed into a semicircular shape in section. The bottom portion 21B is not limited to the curved surface with no angulated portions entirely, but may be formed to have a corner (a corner formed by the bottom portion and the cylindrical inner wall portion 21C). In this case, it is only required that at least the corner at which stress concentration easily occurs is formed into a curved surface, and the other bottom surface may be formed flat.

As shown in FIG. 1(b), the junction 22 of the end member 20 has a hollow portion 22A. The hollow portion 22A is formed into a size to which a rubber bush not shown is fitted via a collar, etc. In the end member 20, a thinning hole, etc., not shown may be formed.

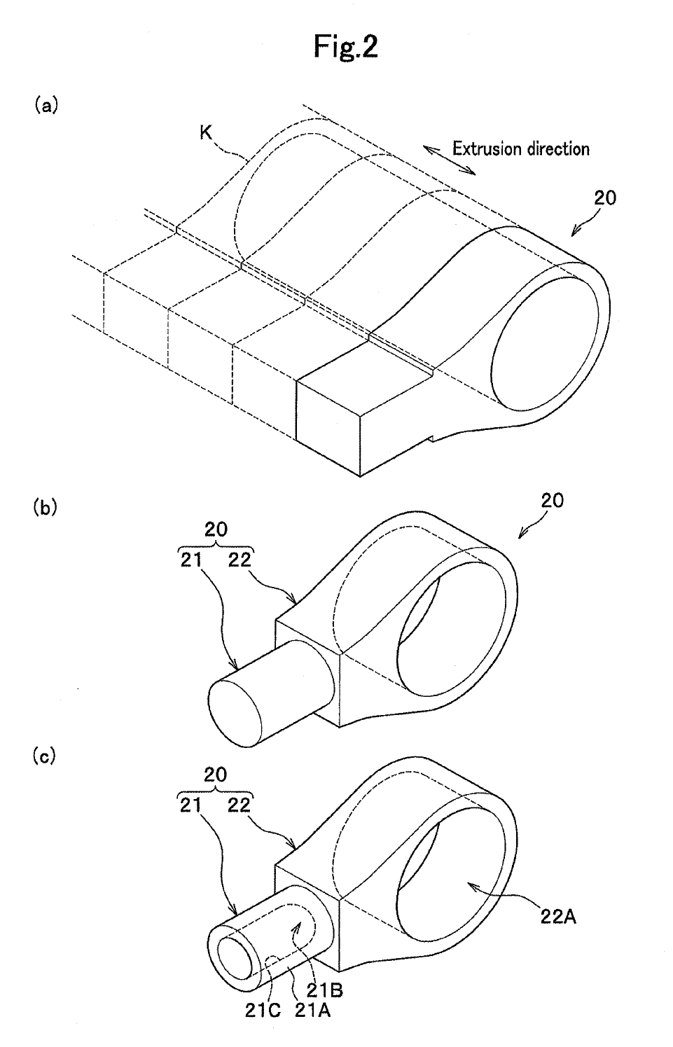

As shown in FIG. 2 (a), such an end member 20 is formed by cutting-out an aluminum alloy-made extrusion material K formed long in the extrusion direction into a predetermined size and machining this cut-out material.

The cut-out end member 20 has a prism-shaped joining portion 21, and is subjected to cutting so that the joining portion 20 is formed into a columnar shape as shown in FIG. 2(b).

Then, as shown in FIG. 2(c), the joining portion 21 is formed into a bottomed cylindrical shape by drilling, and the bottom portion 21B is formed into a semicircular shape in section by machining the angulated portion inside the cylinder into a curved surface. Accordingly, a bottomed cylindrical joining portion 21 which has a cylindrical portion 21A with a uniform section and the inside of which is formed into a curved surface continuing from the cylindrical inner wall portion 21C to the bottom portion 21B is obtained. The formation of the cylindrical portion 21A is not limited to the above-described formation by cutting, and may be a formation by forging or backward extrusion. It is also allowed that the whole end member including the cylindrical portion 21A is formed by forging or casting. Further, it is also allowed that, after the junction is formed by forging or casting, the cylindrical portion is formed by the above-described cutting, forging, and backward extrusion, etc.

The kind of aluminum alloy is not especially limited, however, when the friction welded part 1 is used as a suspension part, preferably, an Al—Mg—Si-based alloy subjected to T6 treatment (JIS 600 series aluminum alloy which was subjected to solution treatment, and then quenched and artificially aged) is used. Particularly, an Al—Mg—Si-based alloy subjected to T6 treatment (aluminum alloy JIS 6061-T6) is more preferable because it has high strength (0.2% proof stress: 245 MPa or more) and high durability (stress corrosion cracking resistance and weather resistance).

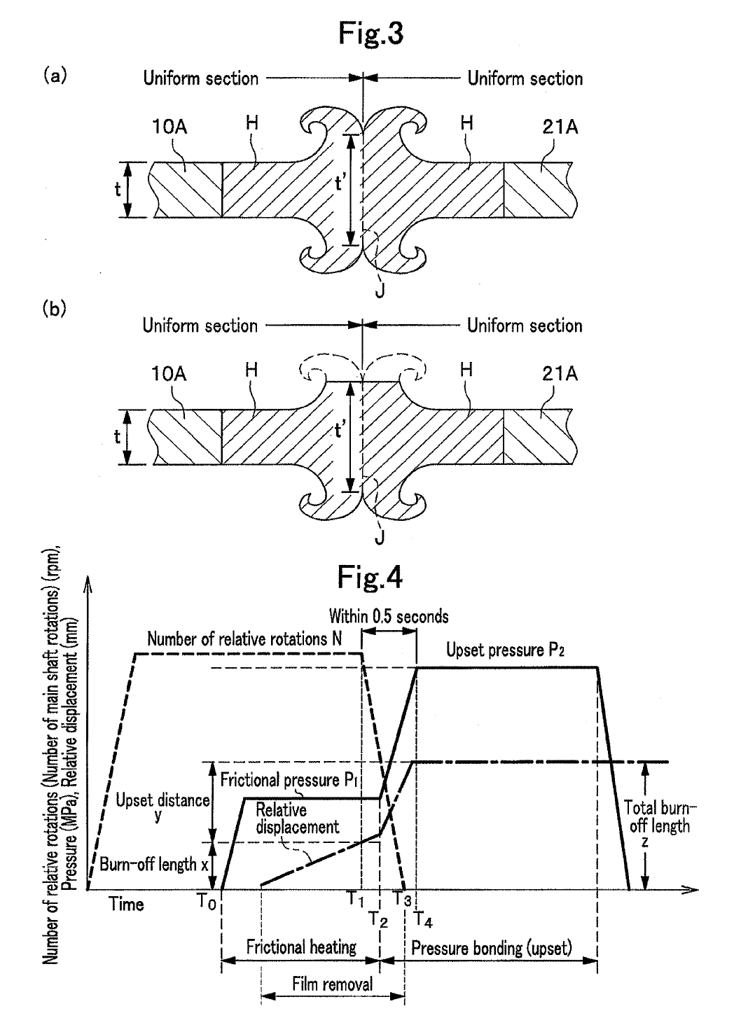

Next, a method for friction welding the rod member 10 and the end members 20 (that is, a method for manufacturing a suspension rod of a friction welded part) will be described in detail with reference to FIG. 1, FIG. 3, and FIG. 4.

The friction welding method of the present embodiment includes a preparation step, a friction step, and an upset step.

In the preparation step, the rod member 10 is held by a clamp of a friction welding machine not shown, and the end member 20 is held on the main shaft of the friction welding machine not shown by a chuck so that the central axis line of the joining portion 21 becomes concentric with the central axis line of the end portion 10A of the rod member 10.

In the friction step, while the rod member 10 and the end member 20 are rotated relative to each other, the end member 20 is moved toward the rod member 10, and the end surface 10a of the end portion 10A of the rod member 10 (see FIG. 1(b)) and the end surface 21a of the cylindrical portion 21A of the end member 20 (see FIG. 1(b)) are butted against each other, and a frictional pressure P₁ is applied to the butting surfaces (that is, the end surface 10a of the rod member 10 and the end surface 21a of the end member 20) as shown in FIG. 4. By thus applying the frictional pressure P₁ to the butting surfaces while the rod member 10 and the end member 20 are rotated relative to each other, around the butting surfaces, a softened portion softer than the base metal is formed due to frictional heat. When the fluidity of the softened portion increases, the softened portion is pushed out to the inside and outside of the end portion 10A and the cylindrical portion 21A and becomes a burr, and as a result, the thickness t′ in the vicinity of the joining interface J increases (see FIG. 3(a)). At this time, an oxide film and adhering matter on the end surface 10a of the rod member 10 and the end surface 21a of the end member 20 before being friction welded are discharged together with the burr.

As shown in FIG. 4, the number of relative rotations (number of rotations of the main shaft) is maintained constant until the time T₁ at which relative displacement (advancing amount of the main shaft) reaches a burn-off length x since the time (time T₀) at which the rod member 10 and the end member 20 were butted against each other, and maintained constant at least while the rod member 10 and the end member 20 are butted against each other and the number of relative rotations N is maintained. In the present embodiment, even after the relative rotation starts to stop (that is, even after reaching the burn-off length x), the frictional pressure P₁ is still applied to the butting surfaces until the time T₂.

The smaller the number of rotations of the main shaft (number of relative rotations of the rod member 10 and the end member 20) and the smaller the frictional pressure P₁ (that is, the smaller the burn-off speed), the longer the time until the temperatures of the butting surfaces rise to a temperature necessary for friction welding. If the butting surfaces are raised in temperature gradually, the frictional heat is radiated from the butting surfaces to the base metal sides, so that not only is the ratio of the frictional heat to be used for friction welding reduced, but also the range of the heat affected zone H increases. In this view, preferably, the number of rotations of the main shaft is set to 1000 per minute or more, and the frictional pressure P₁ is set to 15 MPa or more. If the frictional pressure P₁ is more than 40 MPa, the end portion 10A and the cylindrical portion 21A, etc., may be wrenched off by the rotation force, so that the frictional pressure is preferably set to 40 MPa or less. For example, in the case where the thickness of the end portion 10A of the rod member 10 and the cylindrical portion 21A of the end member 20 is set in the range of 2 to 5 mm, when the number of rotations of the main shaft is set to approximately 1800 per minute and the frictional pressure P₁ is set to approximately 30 MPa, the temperature distributions of the butting surfaces raised in temperature become stable, and the range of the heat affected zone H is reduced.

Herein, the heat affected zone H is a portion which was changed in strength and quality different from those of the base metal due to heat history of the frictional heat, and in the case of friction welding of a JIS 6000 series aluminum alloy (Al—Mg—Si-based alloy), a portion raised in temperature to approximately 300° C. or more corresponds to the heat affected zone.

In the present embodiment, the heat affected zone H of the end member 20 is formed only on the cylindrical portion 21A having a uniform section as described above, and it does not range over the bottom portion 21B and the junction 22 side where the section changes.

The strength of the heat affected zone H becomes smaller than that of the base metal when the rod member 10 and the end members 20 and 20 are made of a thermally-treated alloy (JTS 2000 series aluminum alloy (Al—Cu—Mg-based alloy), JIS 6000 series aluminum alloy (Al—Mg—Si-based alloy), or JIS 7000 series aluminum alloy (Al—Zn—Mg-based alloy)), and becomes greater than that of the base metal when the rod member and the end members are made of a non-thermally-treated alloy (JIS 1000 series aluminum alloy (pure aluminum-based alloy), JIS 3000 series aluminum alloy (Al—Mn-based alloy), or JIS 5000 series aluminum alloy (Al—Mg-based alloy)).

The burn-off speed is determined according to the number of relative rotations N and the frictional pressure P₁. When the number of relative rotations N is set to 1000 per minute or more and the frictional pressure P₁ is set to 15 to 40 MPa, the burn-off speed is 2.5 to 8.0 mm/sec.

The burn-off length x is preferably not less than the thickness t of the end portion 10A and the cylindrical portion 21A. If the burn-off length x is less than t, welding may be ended while the oxide film and adhering matter on the end surfaces 10a and 21a (see FIG. 1(b)) of the end portion 10A and the cylindrical portion 21A are not completely discharged. If an oxide film, etc., remains on the joining interface J, the tension strength may become insufficient. If the burn-off length x is more than 2t, heat generation due to the friction increases and the heat input into the rod member 10 and the end members 20 becomes excessive, so that excessive burrs may occur due to material softening and the heat affected zone H may spread widely.

As described above, when the thickness t of the end portion 10A of the rod member 10 and the cylindrical portion 21A of the end member 20 is set in the range of 2 to 5 mm, the burn-off length x is set to approximately 1.5 t. The burn-off length is a moving distance of the rod member 10 and the end member 20 of one friction joined portion.

The upset step is a step for applying an upset pressure P₂. In the present embodiment, from the time T₂ before the time T₃ at which the number of relative rotations becomes zero after the time T₁ at which the relative rotation starts to stop (that is, the burn-off length x is reached), an increase in pressure is started on the butting surfaces toward the upset pressure P₂. When the pressure reaches the upset pressure P₂, this upset pressure is maintained for a predetermined time to pressure-bond the end portion 10A and the cylindrical portion 21A.

A material having high heat conductivity such as an aluminum alloy more easily lowers in temperature than iron-based materials, so that if the time until the pressure reaches the upset pressure P₂ since the time T₁ at which the relative rotation starts to stop (that is, T₄-T₁) is long, a gap is created in the joined portion due to contraction caused by rapid temperature lowering, and air may enter this gap and form an oxide film. From this point of view, preferably, the prescribed upset pressure P₂ is applied within 0.5 seconds since the time (T₁) at which the relative rotation of the rod member 10 and the end member 20 starts to stop.

When the upset pressure P₂ is applied, continuously from the friction step, the softened portion formed in the friction step is pushed-out to the inside and outside of the end portion 10A and the cylindrical portion 21A, and as a result, a joining interface J with no oxide film, etc., is formed. Thus, by pushing-out the softened portion to the inside and outside of the end portion 10A and the cylindrical portion 21A, the thickness t′ near the joining interface J is formed to be thicker than the thickness t before being friction welded.

The upset pressure P₂ is set to be larger than the frictional pressure P₁, and if it is less than 50 MPa, heat contraction caused by temperature lowering occurs and a gap is created in the member interface, and air may enter this gap and form an oxide film, so that the upset pressure is preferably set to 50 MPa or more. If the upset pressure P₂ is larger than 200 MPa, not only will a large-sized friction welding machine be necessary but also the base metal will buckle or deform, so that preferably, the upset pressure is set to 200 MPa or less. As described above, when the thickness t of the end portion 10A of the rod member 10 and the cylindrical portion 21A of the end member 20 is set in the range of 2 to 5 mm, by setting the upset pressure P₂ to approximately 110 MPa, an oxide film, etc., are discharged without fail, so that a joined portion whose tension strength is high can be formed.

As shown in FIG. 3(b), after the upset step is finished, as necessary, it may be allowed that a burr formed on the outer peripheral side of the welded portion is cut off and the welded portion is formed to be smooth.

In the suspension rod 1 obtained by performing the above-described friction welding method, the joining portions 21 of the end members 20 are formed into bottomed cylindrical shapes corresponding to the end portions 10A of the rod member 10, and the bottom portions 21B of the joining portions are formed into curved surfaces with no angulated portions, so that at these portions (portions where the sectional shape changes), stress concentration does not occur during use after the friction welding. Accordingly, it is not necessary to consider the stress concentration at these portions when designing the suspension rod 1, and the suspension rod is easily designed. Stress concentration is thus prevented, so that the strength is not deteriorated, and the fatigue strength increases and the durability also increases. Accordingly, a suspension rod 1 which can be used for a long time can be manufactured.

In addition, since stress concentration does not occur in the vicinity of the bottom portions 21B formed by drilling, thickening for coping with the stress concentration is not necessary, and the thickness t of the cylindrical portions 21A of the joining portions 21 formed on the end members 20 for friction welding can be reduced, and accordingly, the thickness t of the end portions 10A of the rod member 10 can also be reduced. In other words, the thickness t of both the joining portions 21 and the end portions 10A can be reduced. Therefore, a suspension rod 1 which contributes to weight reduction while maintaining the joining strength is obtained.

Further, the cylindrical portions 21A of the joining portions 21 are formed to have lengths capable of including heat affected zones H when friction welding is performed, so that the heat affected zones H when friction welding is performed are present only on the cylindrical portions 21A with a uniform section, and does not range over the bottom portion 21B sides where the sectional shape changes. Therefore, it is not necessary to consider strength changes due to heat influence on the bottom portion 21B sides, and the suspension rod 1 is easily designed.

The end portions 10A of the rod member 10 and the cylindrical portions 21A of the end members 20 have the same section, so that the design becomes easy. Further, they are joined with the same section, so that when friction welding is performed, the end surfaces 10a of the end portions 10A and the end surfaces 21a of the cylindrical portions 21A are frictionally heated in substantially the same condition, and the heat is transferred to the base metal sides in substantially the same condition, so that the welding balance between these becomes excellent and the joining strength is improved. An advantage of easy welding control, etc., when friction welding is performed is also obtained. Further, the burr shape can also be easily controlled.

The rod member 10 and the end members 20 are formed by cutting-out an aluminum alloy-made extrusion material, so that the productivity of the suspension rod 1 is improved. Further, by utilizing the property of the aluminum alloy which is light and corrosion-inhibiting while its strength is high, a vehicle to which this aluminum alloy is applied can be reduced in weight.

Further, the hollow portion 22A of the end member 20 can be easily formed by cutting-out an aluminum alloy-made extrusion material K, so that the productivity is improved. By machining after cutting-out the end member 20, the cylindrical portion 21A and the bottom portion 21B of the joining portion 21 can be easily formed, so that an advantage of a high degree of freedom in formation of the joining portion 21 is also obtained.

The rod member 10 and the end members 20 and 20 are not necessarily extrusion materials, but may be forged items (including die-casting items). Incidentally, when a suspension part is formed by using the rod member 10 and the end members 20 formed of forged items, an AC4C or ADC3 alloy is preferably used.

The embodiment of the present invention has been described above, and can be variously modified in use.

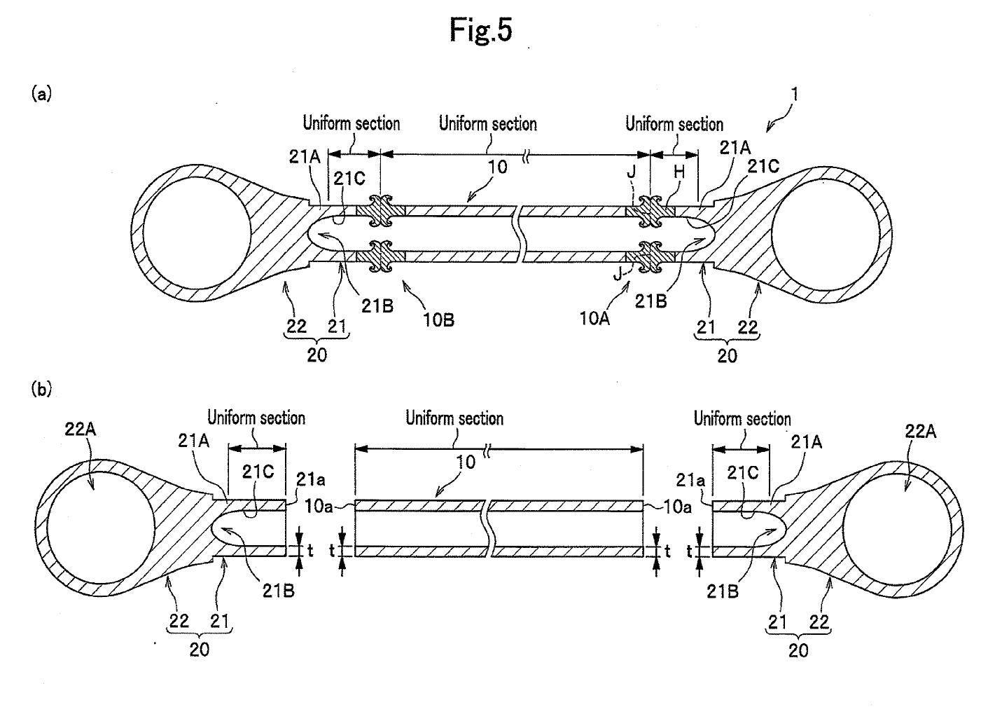

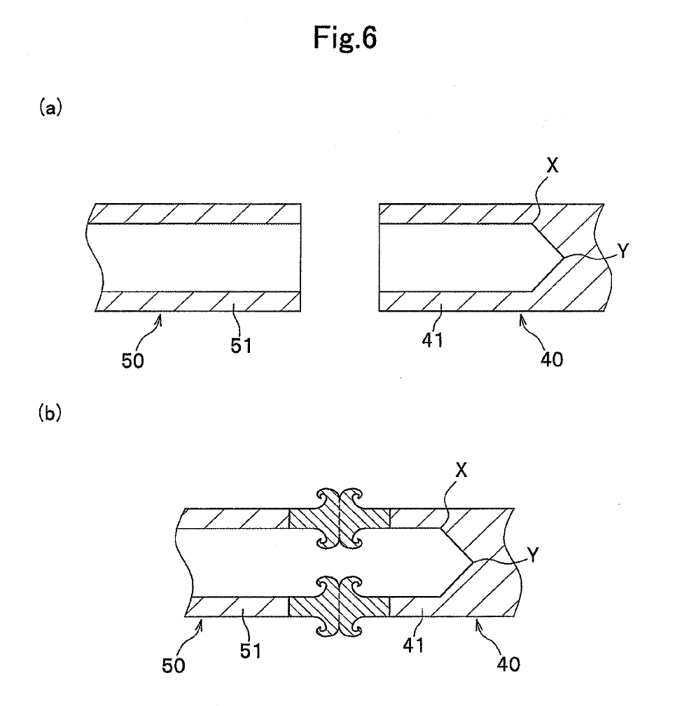

For example, as shown in FIG. 5, the bottom portions 21B of the joining portions 21 of the end members 20 may be formed into semielliptical shapes. By using the joining portions 21 having these bottom portions 21B, the curved surfaces of the portions corresponding to corners can be formed to be gentler in comparison with the case where the bottom portions 21B are formed into semicircular shapes, and stress concentration at these portions is further prevented, and a suspension rod 1 with higher strength is obtained.

What is claimed is:

1. A friction welded part formed by friction welding a first member at least whose first joining portion is formed into a cylindrical shape and a second member having an appropriate shape,
wherein a second joining portion of the second member is formed into a bottomed cylindrical shape corresponding to the first joining portion, and an inside of the cylindrical shape is formed into a curved surface continuing from a cylindrical inner wall portion to a bottom portion; and
wherein the first joining portion of the first member and the second joining portion of the second member are joined by friction welding.

2. The friction welded part according to claim 1,
wherein the bottom portion is formed into a curved surface in the section including an axis line.

3. The friction welded part according to claim 1,
wherein a cylindrical portion of the second joining portion of the second member formed into the bottomed cylindrical shape is formed to have a length capable of including a heat affected zone when the friction welding is performed.

4. The friction welded part according to claim 1,
wherein the second joining portion of the second member has an inner diameter and an outer diameter equal to the inner diameter and the outer diameter of the first joining portion of the first member.

5. A suspension rod formed of the friction welded part according to claim 1, comprising:
a rod member as a first member and end members as a second member, which are formed by cutting an aluminum alloy-made extrusion material,
where the second joining portion having the bottomed cylindrical shape is formed on the end members.

6. The suspension rod according to claim 5,
wherein the end members are formed of an aluminum alloy-made extrusion material having a hollow portion;
a portion where the hollow portion and the second joining portion are formed is formed by cutting-out the aluminum alloy-made extrusion material;
the second joining portion is formed by machining the portion of the cut-out aluminum alloy-made extrusion material; and
a rubber bush is fitted to the hollow portion.

7. A joining method for friction welding a second member having an appropriate shape to a first member at least whose first joining portion is formed into a cylindrical shape, comprising steps of:
forming a second joining portion of the second member into a bottomed cylindrical shape corresponding to the first joining portion;
forming an inside of the cylindrical shape into a curved surface shape continuing from a cylindrical inner wall portion to a bottom portion;
bringing the first joining portion of the first member and the second joining portion of the second member into contact with each other;
butting the first and the second joining portions while rotating the first and the second joining portions relative to each other; and
friction welding the first and the second joining portions.

8. The joining method according to claim 7,
wherein the bottom portion of the second joining portion is formed into a curved surface in section including an axis line.

9. The joining method according to claim 7,
wherein the cylindrical portion of the second joining portion of the second member formed into the bottomed cylindrical shape is formed to have a length capable of including a heat affected zone when the friction welding is performed.
